(19) United States
(12) Patent Application Publication
(10) Pub. No.: US 2026/0169741 A1
(43) Pub. Date: Jun. 18, 2026

(54) SHADOW STACK MANAGEMENT WITH MICRO-OPERATIONS

(71) Applicant: Akeana, Inc., Santa Clara, CA (US)

(72) Inventors: Ricardo Ramirez, Sunnyvale, CA (US); Sundeep Chadha, Austin, TX (US)

(73) Assignee: Akeana, Inc., Santa Clara, CA (US)

(21) Appl. No.: 19/416,028

(22) Filed: Dec. 11, 2025

Related U.S. Application Data
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.
(60) Provisional application No. 63/899,591, filed on Oct. 15, 2025.
(60) Provisional application No. 63/914,824, filed on Nov. 10, 2025.

(51) Int. Cl. G06F 9/30

(52) U.S. Cl. CPC G06F 9/30145; G06F 9/30043; G06F 9/30134

(57) ABSTRACT

A processor core is accessed. The processor core is coupled to a memory hierarchy. The processor core is configured to execute shadow stack operations and micro-operations. A shadow stack operation is decoded. The shadow stack operation is associated with a shadow stack pointer (SSP). The shadow stack operation is associated with an implementation mode. The shadow stack operation is substituted with at least two micro-operations. The substituting is based on the implementation mode. The at least two micro-operations are then executed. The shadow stack operation includes an SSP push operation. A first micro-operation within the at least two micro-operations includes a store micro-operation. A store address of the store micro-operation implicitly comprises the SSP. An illegal instruction exception is triggered when an operand of the SSP push operation is not one or more specified integer registers.

### RELATED APPLICATIONS

This application claims the benefit of U.S. provisional patent applications “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, “Invalidating Snoop Avoidance With Multiple Atomic Loops” Ser. No. 63/899,591, filed Oct. 15, 2025, and “Matrix Multiply Acceleration Based On A Static Partitioning History Table” Ser. No. 63/914,824, filed Nov. 10, 2025.

Each of the foregoing applications is hereby incorporated by reference in its entirety.

### FIELD OF ART

This application relates generally to instruction execution and more particularly to shadow stack management with micro-operations.

### BACKGROUND

Modern computers are designed to run multiple applications concurrently, enabling users to multitask and perform a variety of tasks seamlessly. The applications can include gaming applications. These can be resource-intensive applications requiring high-performance processors. The applications can include productivity applications, such as word processing applications, spreadsheets, and/or presentation software. Another popular category of programs is communications programs. These can include tools for virtual meetings, messaging, and email. Examples of such programs include Zoom, Microsoft Teams, Slack, and Outlook. The applications can include applications for engineering, such as MATLAB, AutoCAD, SolidWorks, and the like. Web browsers are other common applications that are essential for accessing online content and web applications. Examples of such browsers can include Chrome, Firefox, Edge, and others. Yet another popular category of applications includes media players for consuming multimedia content such as videos and music, including streaming content. Examples of such players include VLC media player, Spotify, and/or others. Applications built on Local AI are also increasing in prevalence. Local AI applications are artificial intelligence solutions that run directly on a user's device, such as a smartphone, laptop, or edge computing system, rather than relying on cloud-based services. These applications leverage the processing power of modern hardware to perform complex AI tasks locally. Key reasons for the growing popularity of Local AI applications include the performance increase achieved from processing data locally, eliminating the delay caused by data transmission to and from cloud servers. Another benefit of Local AI applications is that data stays on the device, reducing exposure to potential breaches or misuse in cloud systems. These are just some examples of the many programs and applications that may execute on a computer system.

Modern computer applications often rely on a sophisticated combination of statically linked libraries, dynamically linked libraries, and plugin architectures to achieve performance, modularity, and flexibility. These components play distinct roles in the structure and functionality of software, and together, they enable customizable and extensible applications. The dynamically linked libraries are separate files loaded at runtime, enabling shared use among multiple applications. The dynamically linked libraries also provide the benefits of reduced application size, as applications can link to the libraries at runtime. In addition to the dynamically linked libraries, many applications support a plugin architecture. A plugin architecture allows applications to extend their functionality dynamically by loading additional modules or components. Combining static libraries, dynamic libraries, and plugin architectures provides a robust framework for developing powerful and flexible applications. This hybrid approach promotes applications that are efficient, adaptable, and capable of evolving to meet user needs without sacrificing stability or performance. The combination of linking options provides a balanced trade-off between integration, extensibility, and maintainability in modern software engineering.

The ability to run multiple programs concurrently is fundamental to modern computing. It provides enhanced productivity, allowing users to create documents, attend virtual meetings, and conduct research online simultaneously, streamlining workflows. Moreover, concurrent execution enables activities such as gaming while chatting with friends, or coding with a reference open in another window, promoting effective multitasking. Accordingly, multitasking can create an uninterrupted flow of work, entertainment, or learning, even when switching between applications. Thus, the ability to run multiple applications concurrently is a cornerstone of computing. Multitasking enables flexibility and efficiency across various domains, from productivity and communication to entertainment and AI-driven tasks. However, it requires robust operating systems, well-designed software, and sufficient hardware resources to ensure smooth operation without adverse side effects. This balance is critical for achieving an optimal user experience.

### SUMMARY

The call stack is a fundamental concept in computer programming that supports function execution and ensures that the program can correctly return to the calling function after completing a called function. The call stack acts as a dynamic data structure, implemented as a stack (Last In, First Out, or “LIFO”) in memory, to manage function calls and their execution states. When a function is called, the current execution context (the information about where the function was called from and what to do after the function completes execution) is pushed onto the call stack. This context is stored as a stack frame and can include information such as the return address, which refers to the caller instruction at which to resume execution after the function returns. Additional information can include the arguments passed to the function, as well as space for local variables of the function. The call stack is integral to program execution, but it has limitations and vulnerabilities such as stack overflows, stack corruption, or malicious code that can change a stack pointer to point to code such as a virus, ransomware, etc.

Techniques for instruction execution are disclosed. A processor core is accessed. The processor core is coupled to a memory hierarchy. The processor core is configured to execute shadow stack operations and micro-operations. A shadow stack operation is decoded. The shadow stack operation is associated with a shadow stack pointer (SSP). The shadow stack operation is associated with an implementation mode. The shadow stack operation is substituted with at least two micro-operations. The substituting is based on the implementation mode. The at least two micro-operations are then executed. The shadow stack operation includes an SSP push operation. A first micro-operation within the at least two micro-operations includes a store micro-operation. A store address of the store micro-operation implicitly comprises the SSP. An illegal instruction exception is triggered when an operand of the SSP push operation is not one or more specified integer registers.

A processor-implemented method for instruction execution is disclosed comprising: accessing a processor core, wherein the processor core is coupled to a memory hierarchy, and wherein the processor core is configured to execute shadow stack operations and micro-operations; decoding a shadow stack operation, wherein the shadow stack operation is associated with a shadow stack pointer (SSP), and wherein the shadow stack operation is associated with an implementation mode; substituting the shadow stack operation with at least two micro-operations, wherein the substituting is based on the implementation mode; and executing the at least two micro-operations. In embodiments, the shadow stack operation comprises an SSP push operation. In embodiments, a first micro-operation within the at least two micro-operations comprises a store micro-operation, wherein a store address of the store micro-operation implicitly comprises the SSP. Some embodiments comprise triggering an illegal instruction exception, by a load-store unit within the processor core, wherein an operand of the SSP push operation is not one or more specified integer registers.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for shadow stack management with micro-operations.

FIG. 2 is a flow diagram for popping an SSP with micro-operations.

FIG. 3 is a block diagram of a multicore processor.

FIG. 4 is a block diagram of a pipeline.

FIG. 5 is a first block diagram for shadow stack management.

FIG. 6 is a second block diagram for shadow stack management.

FIG. 7 is a third block diagram for shadow stack management.

FIG. 8 is a system diagram for shadow stack management with micro-operations.

### DETAILED DESCRIPTION

Modern computer systems play a role in nearly every aspect of daily life, executing many types of complex programs concurrently. Complex programs are often developed using functions. The software design practice of breaking tasks into compartmentalized functions, as opposed to writing one monolithic block of “spaghetti code,” is fundamental to good programming. This modular approach organizes code into smaller, self-contained, and reusable pieces, each responsible for a specific task. This also has significant benefits for program organization, maintainability, and testing. Well-named functions clearly convey their purpose, making the code easier to read and understand. Moreover, functions help organize code into a logical hierarchy, with each layer addressing a different abstraction level. Functions can also serve to improve software maintainability, as changes to one function rarely require the rewriting of unrelated parts of the program. Additionally, functions promote code reusability, as a well-designed function can be reused in different parts of the program or even across projects. Functions can also provide improved testing benefits. Functions allow for unit testing, where each function is tested in isolation to ensure that it works as expected. Thus, using software functions to compartmentalize tasks fosters a structured and modular programming approach. It transforms code into smaller, logical components that are easier to understand, maintain, and test. This practice not only reduces the likelihood of bugs, but also enhances the efficiency of development and collaboration, making it a cornerstone of professional software engineering.

The call stack is a concept in computer programming that supports function execution and ensures that the program can correctly return to the calling function after completing a called function. The call stack acts as a dynamic data structure, implemented as a stack (Last In, First Out, or “LIFO”) in memory, to manage function calls and their execution states. When a function is called, the current execution context (the information about where the function was called from and what to do after the function completes execution) is pushed onto the call stack. This context is stored as a stack frame and can include information such as the return address, which refers to the caller instruction at which to resume execution after the function returns. Additional information can include the arguments passed to the function, as well as space for local variables of the function. During execution of the called function, the called function may call a second function, in which case, a new stack frame is created for the new function, and it is added (pushed) to the stack. When a function finishes execution (executes an exit or return statement, or reaches its end), the current stack frame is popped from the call stack. The processor uses the return address in the popped frame to jump back to the location in the calling function where the function call was made. The call stack is essential for managing the flow of execution in a program, enabling seamless function calls and returns. It ensures that every function executes in isolation while maintaining the context necessary to resume the calling function.

The call stack is integral to program execution, but it has its limitations and vulnerabilities. A stack overflow occurs when the program exceeds the maximum allocated stack size. One cause of stack overflow is deep recursion. Deep recursion can occur when a function repeatedly calls itself without a proper termination condition. However, even non-recursive programs can cause a stack overflow if they involve deeply nested function calls. Another cause of stack overflow is large local variables. Declaring overly large variables inside a function can quickly exhaust stack space. The impact of a stack overflow is usually a program crash or termination due to an exception (e.g., segmentation fault, stack overflow error, or the like). However, in some cases, a stack overflow can lead to undefined behavior.

Another related issue is stack corruption. Stack corruption occurs when a program writes invalid data to the stack, overwriting critical information such as return addresses or local variables. This can occur when writing beyond the boundaries of a local array or buffer. Moreover, incorrect use of pointers can overwrite parts of the stack unintentionally. Stack corruption can cause program crashes or undefined behavior. Moreover, when return addresses are corrupted, the affected program can perform unexpected execution sequences, which can have disastrous results in cases where the software is controlling a critical system, such as in avionics, power plant management, or the like. The stack can also be vulnerable to exploitation. Malware can exploit stack-based vulnerabilities to gain unauthorized control over a program. One such exploit is a stack-based buffer overflow, in which an attacker deliberately writes more data to a buffer than it can hold, overwriting the return address or other critical stack values. The overwritten return address is replaced with the address of malicious code injected by the attacker. In a vulnerable program, an attacker could overwrite the stack to point to their own payload, giving them control of the system. Another stack-based exploit is Return-Oriented Programming (ROP). With ROP, instead of injecting new code, an attacker uses snippets of existing code in memory (called “gadgets”) to execute malicious actions.

The call stack is vital for function execution and program flow, but it comes with inherent risks. Stack overflow and corruption can lead to program crashes or vulnerabilities exploitable by malware. To mitigate these risks, disclosed implementations provide an improved shadow stack pointer. The shadow stack pointer of disclosed implementations is a hardware-based mechanism designed to enhance the security and reliability of software by protecting against stack corruption and malicious exploits. The shadow stack pointer (SSP) is used in conjunction with maintaining a separate, isolated copy of the call stack, referred to as the shadow stack, which is inaccessible to normal program operations and thus resistant to tampering. The shadow stack can include one or more stack pointers, return addresses, and so on. With the shadow stack of disclosed implementations, the processor maintains two stacks. A normal stack is used for regular program operations, such as storing local variables, function arguments, and return addresses. In contrast, the shadow stack can store a secure, read-only copy of critical execution metadata, particularly return addresses. In operation, when a function is called, the return address is pushed onto both the normal stack and the shadow stack. The processor verifies that the return address on the normal stack matches the corresponding entry on the shadow stack. In the event of a mismatch, the program halts or raises a security exception, preventing further execution. Moreover, the shadow stack resides in a protected region of memory, managed by hardware. Accordingly, normal program operations cannot directly access or modify the shadow stack, thereby maintaining its integrity.

Processors of disclosed implementations can provide instruction pipelines, in which architectural instructions can be broken into micro-operations for execution. Efficient pipelines can allow multiple micro-operations to run concurrently, increasing instruction throughput. By dividing execution into stages, each stage can be optimized for specific tasks, speeding up processing. Use of a pipeline, or “pipelining,” reduces the time it takes to execute a series of micro-operations by providing the micro-operations to the pipeline. This technique enables the processor to initiate processing of a next operation before the previous operation has completed. Shortening the execution time of individual operations translates to faster overall program execution. The increased processor performance attributable to sequencing of the micro-operations can occur when an operation exploits instruction-level parallelism (ILP). The ILP enables multiple instructions or operations to be in various stages of execution simultaneously. Furthermore, efficient pipelines help maintain a steady flow of operations through the processor, reducing the likelihood of operation stalls or bottlenecks. A seamless operation flow ensures that the processor can consistently perform at or near its peak capabilities.

Disclosed implementations provide a shadow stack that supports micro-operations. Thus, disclosed implementations can provide protection against stack corruption by preventing attackers from tampering with the return addresses. Even if the attacker manages to corrupt the normal stack, the comparison with the shadow stack will fail, ensuring that the stack tampering is detected before attempting further execution with the corrupted stack. Moreover, unlike software-based solutions such as stack canaries, the shadow stack leverages hardware to isolate critical execution data, making it more resistant to tampering and bypass. Thus, the shadow stack pointer is a powerful security mechanism that uses hardware-based isolation to protect against stack corruption and thwart malicious actors. Ensuring the integrity of return addresses significantly reduces the risk of exploits such as buffer overflows and ROP attacks. Its integration into modern processors underscores the growing emphasis on hardware-enforced security in an increasingly threat-filled landscape.

Techniques for instruction execution are disclosed. A processor core is accessed. The processor core is coupled to a memory hierarchy, and the processor core is configured to execute shadow stack operations and micro-operations. A shadow stack operation is decoded, in which the shadow stack operation is associated with a shadow stack pointer (SSP), and the shadow stack operation is associated with an implementation mode. The shadow stack operation can comprise an SSP push operation. An illegal instruction exception can be triggered by a load-store unit within the processor core, wherein an operand of the SSP push operation is not one or more specified integer registers. The shadow stack operation can comprise an SSP pop operation. The executing can be based on a temporary register associated with the at least two micro-operations, which can be renamed. The shadow stack operation is substituted with at least two micro-operations, where the substituting is based on the implementation mode. The at least two micro-operations are then executed, thereby providing shadow stack support for micro-operations. Interrupts can be prevented from occurring between the at least two micro-operations. The SSP can be renamed within the processor core.

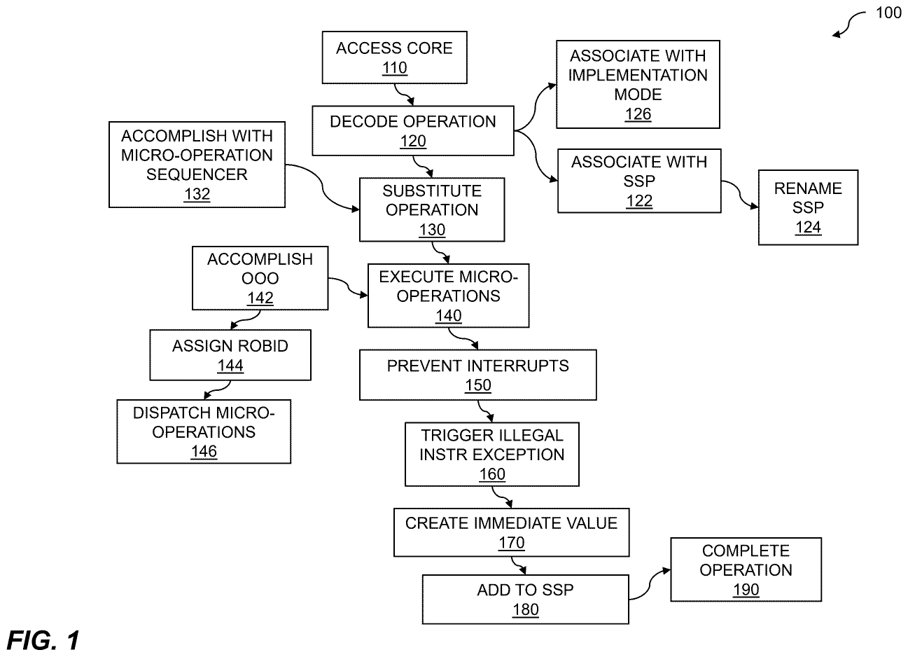

FIG. 1 is a flow diagram for shadow stack management with micro-operations. The flow 100 includes accessing a processor core 110. Embodiments include accessing a processor core, wherein the processor core is coupled to a memory hierarchy, and wherein the processor core is configured to execute shadow stack operations and micro-operations. The processor core can be included on a multi-processor chip, an application specific integrated circuit (ASIC), a system-on-a-chip (SOC), and so on. The processor core can include a RISC-V core, MIPS core, ARM core, and so on. The processor core is coupled to a memory hierarchy. The memory hierarchy can include multiple cache levels, memory, and/or other storage technologies. The processor core can execute instructions that are part of an instruction set architecture (ISA) such as X86, ARM, and so on. The memory hierarchy can include L1, L2, L3, etc. caches. The memory hierarchy can include memory such as DRAM, SDRAM, and so on. The memory hierarchy can be coherent or non-coherent. In embodiments, the processor core is configured to execute shadow stack operations and micro-operations. The micro-operations can comprise a series of less complex instructions that can take the place of a single, more complex instruction. A micro-operation sequencer can be used for vector instructions, scalar instructions, floating-point instructions, stack operations, and so on. The shadow stack operations can include a push, pop, check, and so on. The push operation can store an address to the shadow stack. A pop operation can read an address from the shadow stack, and a check operation can check that the shadow stack pointer is equivalent to a stack pointer. Any of the shadow stack operations can be substituted with at least two micro-operations.

The flow 100 includes decoding a shadow stack operation 120. Embodiments can include decoding a shadow stack operation, wherein the shadow stack operation is associated with a shadow stack pointer (SSP). The decode operation can include decoding an instruction which can include identifying opcodes, operands, control signals, and the like. The shadow stack operation is associated with a shadow stack pointer (SSP). The shadow stack pointer can point to a shadow stack. The shadow stack can be a copy of the stack. The shadow stack can include one or more stack pointers, return addresses, and so on and can be used for security and/or checking purposes. The shadow stack is associated with a shadow stack pointer (SSP) 122. The shadow stack and SSP can be located in a protected memory area that user-level operations cannot access. The location of these elements in a protected memory area serves as an impediment to malicious tampering of the stack and associated parameters, such as the stack pointer. The SSP can point to a location in the shadow stack which contains an address to where program execution should continue when a function that was called completes. The address pointed to by the SSP can be compared to the address pointed to by the stack pointer (SP) to ensure that corruption has not taken place. In embodiments, the SSP is renamed 124 within the processor core. The renaming of the SSP can serve to improve processor performance by increasing instruction-level parallelism. In disclosed implementations, a register renaming technique is used to improve performance and eliminate hazards related to the use of registers, including registers associated with a shadow stack, during instruction execution. In a processor, true and false data hazards/dependencies can occur. An example of a true dependency is a read-after-write (RAW) dependency. In a RAW dependency, a write must generate results before new results can be read. This requires the instructions to execute in order. An example of a false dependency is write-after-read (WAR). A WAR is a “dependency” in which a second instruction uses a register to store results, the register having also been used by a previous instruction to read results. If the two institutions were to execute out of order, an error could result. This can be resolved through register renaming. That is, the second instruction can use a different physical register to store results, thus enabling both instructions to execute out of order in the processor core, increasing performance.

The shadow stack operation is associated with an implementation mode 126. Computer architectures such as RISC-V (Reduced Instruction Set Computing-V) architectures can be designed to be flexible and extensible, allowing different implementations to include a wide range of extensions based on the specific needs of the customer, design use, etc. These extensions can be added to the base architecture to support additional functionality, performance improvements, power efficiencies, and so on. The extensions can enable a variety of features such as floating-point functionality, compressed instruction functionality, vector operations, and more. One category of extensions includes security extensions, including an extension to support a shadow stack. The collection of extensions that are enabled for a given implementation can be referred to as an implementation mode.

The flow 100 includes substituting the shadow stack operation 130 with at least two micro-operations. The micro-operations can include instructions for loading (pushing) an address value onto the shadow stack, retrieving (popping an address value from the shadow stack), computing an address location for a new stack frame, validating one or more stack frame parameters, and so on. In embodiments, the substituting is accomplished by a micro-operation sequencer 132. In exemplary implementations, the micro-operation sequencer can be implemented as a finite state machine, which takes inputs that can include a type register, a source register, a destination register, and/or other operands. The micro-operation sequencer logic can implement architectural instructions by breaking the instruction into individual micro-operations. The micro-operation sequencer can be included in a decode unit of the processor core. The substituting is based on the implementation mode. As described earlier, an implementation mode can be optionally included by the processor core. When the implementation mode is supported, the processor core can substitute micro-operations for shadow stack operations and execute them. However, when the implementation mode is not enabled, supported, designed, etc., and an unsupported instruction such as a shadows stack operation is fetched, the processor can execute a no-op or another instruction.

The flow 100 includes executing the at least two micro-operations 140. The micro-operations can include instructions for storing values to registers, reading values from registers, comparing values in registers and/or memory locations, and so on. In embodiments, the executing is accomplished out of order (OoO) 142. Out-of-order (OoO) instruction execution is a technique used in modern processors to improve performance by allowing instructions to be executed in an order different from the one specified by the program, as long as data dependencies and resource availability are maintained. This helps in utilizing processor resources more efficiently, minimizing idle times, and increasing instruction throughput. In exemplary implementations, the processor continuously fetches instructions from memory (or an instruction cache) and places them into a queue, typically referred to as the instruction buffer or instruction window. Each fetched instruction is decoded, and the processor determines what the instruction does (e.g., add, load, branch) and what operands (registers or memory locations) are involved. At this point, the instruction can be broken down into micro-operations, depending on the type of instruction. Dependencies for each instruction and/or micro-operation may be analyzed. Instructions that are ready (i.e., their operands are available, and there are no data hazards) are dispatched to available execution units (such as ALUs, floating-point units, load/store units, etc.) as soon as these units are free. This dispatch can happen out of order, meaning an instruction that appears later in the program might be executed earlier if its dependencies are resolved first, while earlier instructions are waiting for their operands. Out-of-order execution can provide increased instruction throughput, improved resource utilization, and improved efficiency in handling branching, among other benefits.

In embodiments, the substituting includes assigning, by a reorder buffer (ROB), a reorder buffer identification (ROBID) 144 associated with each of the at least two micro-operations. A reorder buffer identification (ROBID) parameter can be used to ensure that all instructions are retired in order, while still supporting out-of-order (OoO) execution. In one or more implementations, a dispatch stage can maintain a reorder buffer (ROB) that indicates an arrival order in the dispatch stage. An execution stage can follow the dispatch stage. The ROB is used to ensure proper sequencing, committing, and retiring of instructions. The retiring can include successfully completing the execution and writing the results of the instruction back to the register file and/or memory. Upon retirement, the instruction is removed from the pipeline. The dispatch unit can maintain a reorder buffer identifier (ROBID) that is used to ensure that instructions are completed in the correct program order, while still supporting an out-of-order instruction architecture. Embodiments include dispatching the at least two micro-operations 146, wherein the dispatching is based on the ROBID. The dispatching can include sending micro-instructions to one or more execution units. The execution units can include one or more execution units to support shadow stack operations. The ROB can enable proper instruction retirement by ensuring that instructions and/or micro-operations are completed and results are written back in the correct program order.

The flow 100 includes preventing interrupts 150 from occurring between the at least two micro-operations. In exemplary implementations, interrupts are prevented while executing micro-operations that pertain to a single architectural instruction. Since the micro-operations generated by the micro-operation sequencer are not defined by the architecture, an interrupt that occurs between the execution of micro-operations can result in an undefined architectural state. Thus, preventing interrupts from occurring between micro-operations can preserve data integrity and system stability. This is crucial when micro-operations perform functions such as updating or checking a shared state.

The flow 100 continues with triggering an illegal instruction exception 160. In embodiments, the shadow stack operation comprises an SSP push operation. An SSP push operation can store an address to the shadow stack. The SSP push operation can be in response to a function call so that a return address can be added to the shadow stack. The return address can later be compared to the SP to ensure that corruption of the stack has not occurred. In further embodiments, a first micro-operation within the at least two micro-operations comprises a store micro-operation, wherein a store address of the store micro-operation implicitly comprises the SSP. The store micro-operation can store the return address to the shadow stack. The store address of the first micro-operation does not need to be explicitly given. Instead, it can implicitly comprise the SSP. An operand of the store micro-operation can be a register within the integer register file, which can be denoted with an “X”. For example, X2 can represent integer register 2. Some embodiments include triggering an illegal instruction exception, by a load-store unit within the processor core, wherein an operand of the SSP push operation is not one or more specified integer registers. By convention, the SSP push operation can include the address to be pushed in one or more registers, such as X1 or X5. For example, in a RISC-V processor, X1 is one of the general-purpose registers, and it is conventionally referred to as RA, which stands for “Return Address.” A main purpose of the RA register is to hold the return address when a function call is made. For example, when a function is called using the JAL (Jump and Link) or JALR (Jump and Link Register) instructions, the return address (the address of the instruction immediately following the call) can be stored in X1. In exemplary implementations that provide enhanced security features such as a shadow stack, the value stored in the RA can be verified against a protected memory region to ensure control-flow integrity and to prevent return-oriented programming (ROP) attacks.

When the address to be pushed is not included in a pre-defined register, the processor core can raise an illegal instruction exception. That is, operands stored in registers other than X1 and/or X5 registers can cause an illegal instruction exception to be triggered. This feature provides an additional level of robustness and security by preventing instructions that have incorrect operands. Executing instructions with invalid operands can lead to undefined behavior or a corrupt system state. Halting execution when illegal operands are detected can ensure that errors do not propagate to other parts of the system. Moreover, by detecting and stopping invalid instructions, the processor can generate a specific exception or interrupt. The functions of the shadow stack of disclosed implementations allow the operating system or software to handle the error gracefully, such as through recovery routines and/or logging.

The flow 100 includes creating an immediate value 170. In embodiments, a second micro-operation within the at least two micro-operations comprises a decrement micro-operation. Once the return address is pushed onto the shadow stack, the SSP can be decremented. The decrementing can move the SSP to the top of the stack, where another store micro-operation from a different shadow stack operation can store another return address. In embodiments, the execution of the decrement operation depends on a successful completion of the store micro-operation. If the store micro-operation fails, the SSP cannot be moved as doing so would corrupt the shadow stack. In other embodiments, a source and a destination of the decrement micro-operation implicitly comprise the SSP. There is no need for the decrement micro-operation to include a specific destination since the micro-operation was specifically created by the micro-operation sequencer to decrement the SSP. Thus, the SSP can be both the implicit source and destination of the decrement micro-operation. The decrement can be accomplished with an immediate value.

The flow 100 includes adding the immediate value to the SSP 180. Exemplary implementations can utilize a descending stack architecture, in which case a stack push operation involves decrementing the stack pointer value. In a descending stack, the stack grows downward in memory, meaning that each new entry occupies a lower memory address than the previous one. Since in the case of a push operation, as described above, the SSP must be decremented, the immediate value can be a twos complement value. Embodiments include creating an immediate value, wherein the immediate value comprises a twos complement of an equation: [XLEN/8], wherein XLEN is a length of an integer register file, and wherein the immediate value is added to the SSP. The equation [XLEN/8] can determine whether a processor includes 64-bit addressing, 32-bit addressing, and so on. Thus, [XLEN/8] can be an immediate value corresponding to a single “step” in a memory address such as a stack frame. Accurately computing the size of a stack frame when pushing or popping entries from a program stack is crucial for supporting function calls in conjunction with a shadow stack of disclosed implementations. Incorrect stack frame size computations can cause the stack pointer to overwrite existing data, such as local variables, return addresses, or saved registers, leading to data corruption, or a false positive of a stack corruption exception when comparing the normal stack with the shadow stack.

The flow 100 includes completing the shadow stack operation 190, wherein the completing is based on a ROBID associated with each micro-operation within the at least two micro-operations. An older instruction can be indicated by a lower ROBID. The ROBID can include a wrap-around bit to determine the oldest instruction. In disclosed examples, the instruction associated with the lowest ROBID is the oldest instruction and is the instruction that can be issued first. The completion of the operation can include pushing a new value onto the shadow stack, or popping a value from the shadow stack, and adjusting the SSP accordingly.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

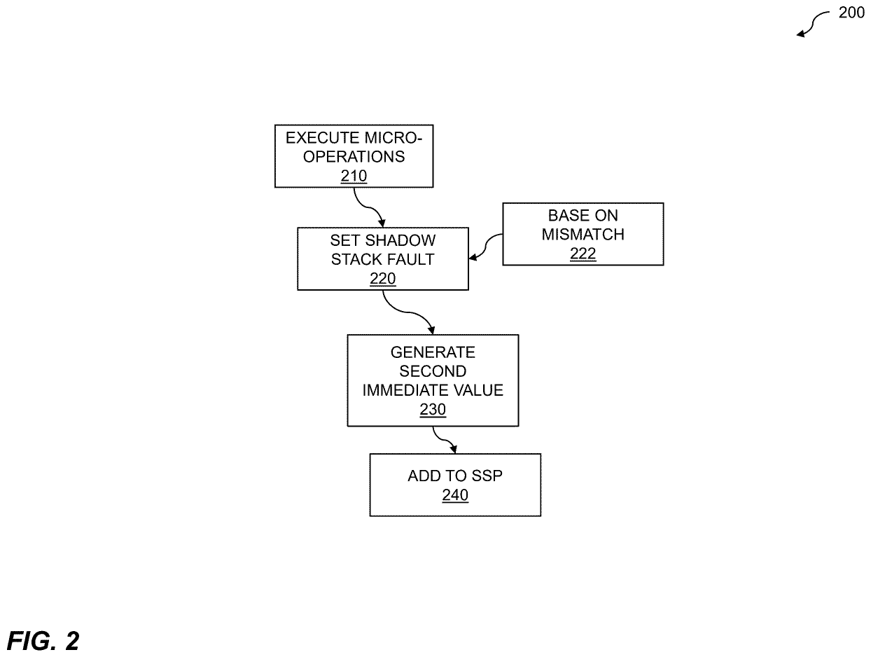

FIG. 2 is a flow diagram for popping an SSP with micro-operations. As described above and throughout, a shadow stack operation can be substituted by a micro-operation sequencer with at least two micro-operations. In the flow 200, at least two micro-operations can be executed 210, which can include out-of-order execution. The micro-operations can include instructions for storing values to registers, reading values from registers, comparing values in registers and/or memory locations, and so on. In embodiments, the shadow stack operation comprises an SSP pop operation. When a called function returns, the return address can be found in the shadow stack. This return address can be compared to a return address found in the stack. If these addresses match, program execution can continue at the return address. If the addresses do not match, the processor can raise a fault, such as a shadow stack fault, indicating the mismatch. An SSP pop operation can read an address from the shadow stack and can update the SSP to point to the next address in the shadow stack.

In embodiments, the executing is based on a temporary register associated with the at least two micro-operations. The temporary register can be used to hold the address that was popped from the SSP pop operation. The address within the temporary register can then be compared to the address pointed to by the SP to ensure that a match is found before instruction execution is allowed to continue at the address that matched. In further embodiments, the temporary register is renamed. As explained above, renaming can eliminate false dependencies, increasing performance in some code sequences by allocating a different physical register to an instruction.

When the shadow stack operation is an SSP pop operation, a first micro-operation can be a load micro-operation. In embodiments, a first micro-operation within the at least two micro-operations comprises a load micro-operation, wherein a load address of the load micro-operations implicitly comprises the SSP, and wherein a destination address comprises the temporary register. The destination address of the first micro-operation does not need to be explicitly given. Instead, it can implicitly comprise the SSP. The load operation can read the value pointed to by the SSP from the shadow stack. In further embodiments, a second micro-operation within the at least two micro-operations comprises a compare micro-operation, wherein a first source operand of the compare micro-operation comprises the temporary register, and wherein a second source operand of the compare micro-operation comprises a stack pointer (SP). As described above and throughout, a comparison can be made between the address pointed to by the SSP and the address pointed to by the SP. After the temporary register has been loaded with the address pointed to by the SSP, it can be compared to the address pointed to by the SP. When the source operands of the compare instruction match, it can be assumed that no corruption of the stack pointer has occurred.

The flow 200 includes setting a shadow stack fault 220, wherein the first source operand and the second source operand do not match 222. This mismatch can be between the shadow stack and the regular stack. In exemplary implementations, during a function return, the return address from the regular stack is compared to the address in the shadow stack. When the SSP and the SP do not match, it can be assumed that corruption of the stack has occurred. A shadow stack fault in a RISC-V processor can refer to an error or exception triggered when the shadow stack mechanism detects an inconsistency or violation in the integrity of the shadow stack. Shadow stacks of disclosed implementations can be used as a security feature to protect against control flow attacks, such as return-oriented programming (ROP), by maintaining a secure copy of return addresses.

In embodiments, a third micro-operation within the at least two micro-operations comprises an increment micro-operation, wherein a source and a destination of the increment micro-operations implicitly comprise the SSP. As described above, the processor core can utilize a descending stack architecture, in which case a stack pop operation involves incrementing the stack pointer value. In a descending stack, the stack grows downward in memory, meaning that each new entry occupies a lower memory address than the previous one. Thus, in the case of a pop operation, the SSP must be incremented. There is no need for the increment micro-operation to include a specific destination since the micro-operation was specifically created by the micro-operation sequencer to increment the SSP. Thus, the SSP can be both the implicit source and destination of the incremented micro-operation. The increment can be accomplished with a second immediate value.

The flow 200 includes generating a second immediate value 230. Once the return address is popped from the shadow stack, the SSP can be incremented. The SSP can be incremented by adding the second immediate value to the SSP to update the stack address that the SSP points to. The incrementing can move the SSP to the new top of the stack, where another pop operation can obtain, or pop, another return address. As the shadow stack pointer operates in tandem with the regular stack, proper configuration of the shadow stack is important for achieving improved security in program execution. Embodiments include generating a second immediate value, wherein the second immediate value comprises a result of an equation: [XLEN/8], wherein XLEN is the length of an integer register file, and wherein the second immediate value is added to the SSP 240. Adding (for a pop) or subtracting (for a push) an immediate value from the shadow stack pointer (SSP) in a processor is a key operation that is important for monitoring the integrity of the regular stack. In general, the stack pointer controls where the top of the stack is located in memory. By adjusting the stack pointer, it is possible to allocate or deallocate space for function calls, local variables, return addresses, and other data structures. This cleanup is critical for ensuring that subsequent function calls do not overwrite data on the stack. It should be noted that adding can be used for a push and subtracting for a pop in some implementations such as an ascending stack architecture.

The equation [XLEN/8] can determine whether a processor includes 64-bit addressing, 32-bit addressing, and so on. Thus, [XLEN/8] can be an immediate value corresponding to a single “step” in a memory address such as a stack frame. Accurately computing the size of a stack frame when pushing or popping entries from a program stack is crucial for supporting function calls in conjunction with a shadow stack of disclosed implementations. Incorrect stack frame size computations can cause the stack pointer to overwrite existing data, such as local variables, return addresses, or saved registers, leading to data corruption, or a false positive of a stack corruption exception when comparing the normal stack with the shadow stack.

One or more exemplary implementations may further include using a hashing algorithm to compute a hash of stack frames in both a regular stack and a shadow stack in order to provide an additional level of security, even if the return addresses match. This approach can help detect mismatches or tampering within the stack frame, offering an enhanced defense against attacks like return-oriented programming (ROP) and/or stack buffer overflows. By using a hashing algorithm on the entire stack frame (or relevant portions) in both the regular stack and the shadow stack, it is possible to detect if any part of the stack has been altered, even if the return address itself appears unmodified. With the disclosed implementations that utilize hashing, in addition to just checking return addresses, the hashing can provide a way to verify the integrity of the entire stack frame, including saved registers, local variables, and any other stack-based data. If any part of the stack is tampered with, it will affect the hash value, thereby triggering a mismatch detection. One or more implementations may utilize a hash function such as SHA-256 or SHA-3 in order to compute a hash over the stack frame. Thus, exemplary implementations can provide an additional layer of security against advanced attacks that could manipulate some parts of the stack frame but leave the return address intact.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

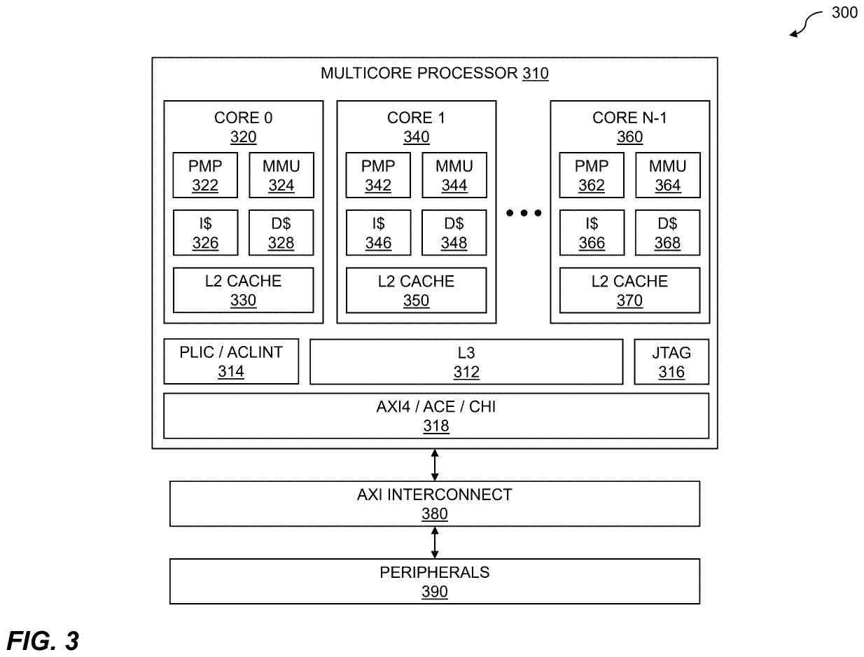

FIG. 3 is a block diagram of a multicore processor. The processor, such as a RISC-V™ processor, an ARM processor, or other suitable processor type, can include a variety of elements. The elements can include processor cores including multiprocessor cores, one or more caches including local caches and shared caches, memory protection and management units, local storage, and so on. The elements of the multicore processor can further include one or more of a private cache; a test interface such as a joint test action group (JTAG) test interface; one or more interfaces to a network such as a network-on-chip, shared memory, and peripherals; and the like.

In the block diagram 300, the multicore processor 310 can comprise two or more processors, where the two or more processors can include homogeneous processors, heterogeneous processors, etc. In the block diagram, the multicore processor can include N processor cores such as core 0 320, core 1 340, core N-1 360, and so on. Each processor can comprise one or more elements. In one or more implementations, each core, including cores 0 through core N-1, can include a physical memory protection (PMP) element, such as PMP 322 for core 0, PMP 342 for core 1, and PMP 362 for core N-1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N-1. The memory management units can translate virtual addresses used by software running on the cores to physical memory addresses within caches, the shared memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0, an instruction cache I$ 346 and a data cache D$ 348 associated with core 1, and an instruction cache I$ 366 and a data cache D$ 368 associated with core N-1. In addition to the level 1 instruction and data caches, each core can include a level 2 (L2) cache. The level 2 caches can include L2 cache 330 associated with core 0, L2 cache 350 associated with core 1, and L2 cache 370 associated with core N-1. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all of the cores. The further elements can be shared among the cores. In one or more implementations, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces including an Advanced eXtensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In one or more implementations, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

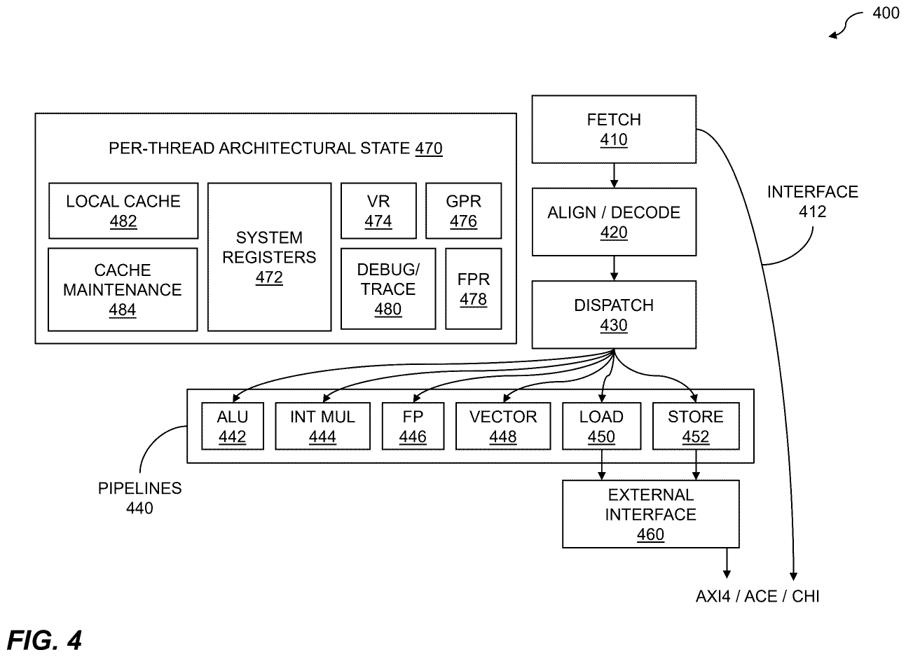

FIG. 4 is a block diagram of a pipeline. One or more pipelines associated with a processor architecture can be used to greatly enhance processing throughput. The processor architecture can be associated with one or more processor cores. The processing throughput can be increased because multiple operations can be executed in parallel. In one or more implementations, a processor core is accessed. The processor core is coupled to a memory hierarchy, and the processor core is configured to execute vector operations, scalar operations, and various micro-operations that implement architectural instructions.

The blocks within the block diagram can be configurable in order to provide varying processing levels. The varying processing levels can be based on processing speed, bit lengths, word lengths, numbers of micro-operations, and so on. The block diagram 400 can include a fetch block 410. The fetch block 410 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced eXtensible Interface (AXI™), an ARM™ Advanced eXtensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450, and store pipelines 452. The load pipelines and the store pipelines can access storage such as the common memory using an external interface 460. The external interface can be based on one or more interface standards such as the Advanced eXtensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 470. The inclusion of the per-thread architectural state can be based on a configuration or architecture that can support multi-threading. In one or more exemplary implementations, thread selection logic can be included in the fetch and dispatch blocks discussed above. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VRs) 474. The vector registers can be grouped in a vector register file and can be used for vector operations. In one or more exemplary implementations, the width of the vector register file is 512 bits. Additional registers, such as general-purpose registers (GPRs) 476 and floating-point registers (FPRs) 478, can be included. These registers can be used for general purpose (e.g., integer) operations and floating-point operations, respectively. The per-thread architectural state can include a debug and trace block 480. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

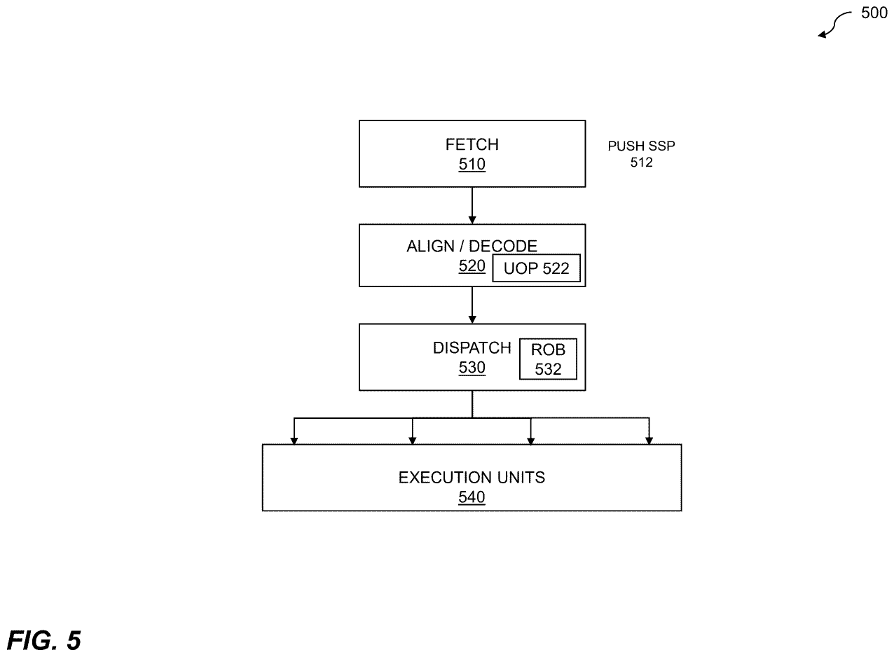

FIG. 5 is a first block diagram for shadow stack management. Instructions, such as stack operations, including push operations, pop operations, stack frame validation operations, stack exception generation operations, and so on, can be fetched from a fetch unit. In one or more examples, the fetch unit can perform functions such as retrieving the next instruction from memory based on a program counter (PC). The fetch unit may also perform functions that include incrementing the PC to point to the next instruction. In one or more examples, the fetch unit can also participate in branch prediction to improve instruction flow efficiency. The fetch unit can prefetch instructions that are deemed likely to be executed. Additionally, the fetch unit can interact with one or more instruction caches to reduce latency when fetching instructions. In the block diagram 500, the fetch unit 510 can fetch stack operations. In the block diagram 500, a push SSP instruction 512 is being fetched.

Once instructions are fetched, the instructions are provided to the align/decode unit 520. The align/decode unit may perform functions that include aligning instruction boundaries to ensure proper processing. The decoding by the align/decode unit can include dividing an instruction such as a shadow stack operation into multiple micro-operations for further processing. This can be accomplished by a micro-operation sequencer 522. Additionally, the align/decode unit can perform operations of translating binary instruction codes into control signals and fields needed for execution and also of identifying and retrieving operands from registers based on the instruction. The operands can include, but are not limited to, register operands, immediate operands (to support constants embedded directly within the instruction), memory operands, PC-relative operands (addresses calculated relative to the current value of the program counter, often used for branching), indexed operands, and/or other types of operands. In one or more examples, the align/decode unit may be similar to the align/decode block 420 shown in FIG. 4.

The fetched instructions can be provided to the dispatch unit 530. The dispatch unit can include a reorder buffer (ROB) 532. In one or more examples, the ROB can keep track of the order of micro-operations as they are issued and executed out of order. The ROB can enable proper micro-operation retirement by ensuring that micro-operations such as memory loads and memory stores are completed, and that the loads and the stores are performed in the correct program order. The ROB can include multiple entries, where each entry corresponds to an instruction in the dispatch unit. A reorder buffer identification (ROBID) can refer to an entry in the ROB.

The micro-operations, along with other architectural instructions, can be provided to corresponding execution units 540. The execution units can include load-store units, arithmetic execution units, floating-point execution units, shadow stack processing execution units, and so on. In exemplary implementations, each execution unit can have a corresponding instruction queue for storing instructions to be executed. In exemplary implementations, one or more muxes may be used to route instructions and/or micro-operations to their respective input queues.

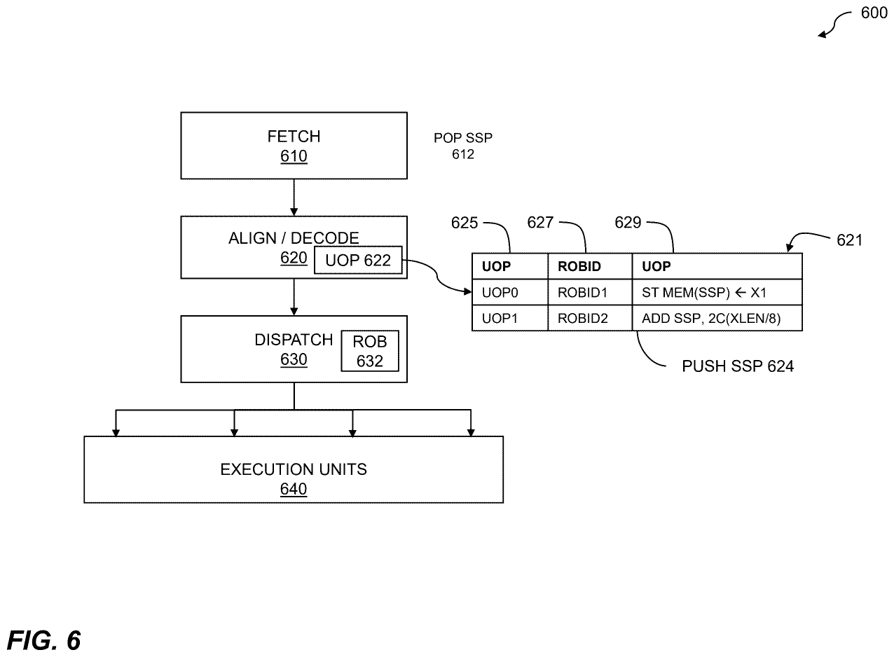

FIG. 6 is a second block diagram for shadow stack management. The example shown in FIG. 6 continues from the example shown in FIG. 5. In the block diagram 600, the push SSP instruction (512 from FIG. 5) has advanced to the align/decode unit 620 and is shown as push SSP instruction 624. In embodiments, the shadow stack operation comprises an SSP push operation. The push SSP instruction 624 is converted into two micro-operations by a micro-operation sequencer 622. Details of each micro-operation are shown in table 621. Table 621 includes a column 625 that contains a micro-operation identifier. Table 621 further includes a column 627 that contains a ROB identifier (ROBID) corresponding to each micro-operation. Column 629 includes a micro-operation instruction. The first micro-operation (UOP0) includes an instruction to store the address at X1 in the shadow stack to the location pointed to by the stack pointer. By convention, the SSP push operation can include the address to be pushed in one or more registers, such as X1 or X5. Some embodiments include triggering an illegal instruction exception, by a load-store unit within the processor core, wherein an operand of the SSP push operation is not one or more specified integer registers.

In embodiments, a first micro-operation within the at least two micro-operations comprises a store micro-operation, wherein a store address of the store micro-operation implicitly comprises the SSP. The first micro-operation (UOP0) has a ROBID of ROBID1. The second micro-operation (UOP1) includes an instruction to add a twos complement of the value of XLEN divided by 8 to the shadow stack pointer, effectively decrementing the shadow stack pointer to reference the next stack frame. The second micro-operation (UOP1) has a ROBID of ROBID2. In embodiments, a second micro-operation within the at least two micro-operations comprises a decrement micro-operation. In embodiments, execution of the decrement micro-operation depends on a successful completion of the store micro-operation.

The subsequent instruction is a pop SSP instruction 612, which occurs at the fetch unit 610. Note that in practice, generally there are additional instructions between the push SSP instruction 624 and the subsequent pop SSP instruction 612. These additional instructions typically would implement a function call, and upon exit of the function call, the pop SSP instruction obtains the return address needed to resume program execution. However, in the interest of clarity for illustrating the operation of the shadow stack in disclosed implementations, the additional instructions are omitted in the example shown in FIG. 6. The dispatch unit 630, ROB 632, and execution units 640 are similar to the elements with like reference numbers shown in FIG. 5.

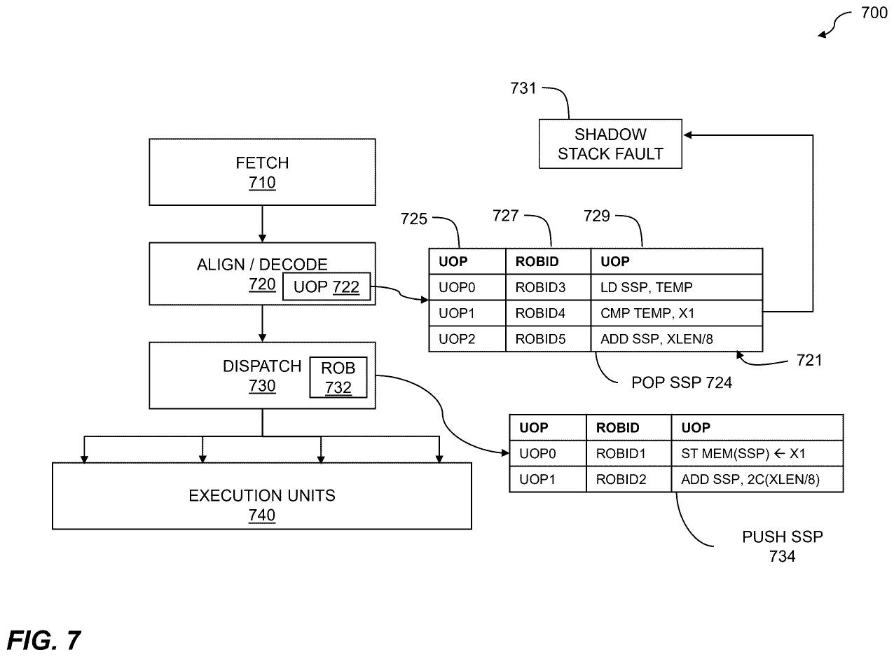

FIG. 7 is a third block diagram for shadow stack management. The example shown in FIG. 7 continues from the example shown in FIG. 6. In the block diagram 700, the fetch unit 710, align/decode unit 720, micro-operation sequencer 722, and execution units 740 are similar to previously described corresponding elements in FIG. 5 and FIG. 6. The push SSP instruction 734 is loaded into the ROB 732 within the dispatch unit 730. In embodiments, the shadow stack operation comprises a SSP pop operation. The pop SSP instruction 724 is divided into three micro-operations, as shown in table 721. Table 721 includes a column 725 that contains a micro-operation identifier. Table 721 further includes a column 727 that contains a ROB identifier (ROBID) corresponding to each micro-operation. Column 729 includes a micro-operation instruction. The first micro-operation (UOP0) includes an instruction to load the SSP into a temporary register. The first micro-operation (UOP0) has a ROBID of ROBID3. In embodiments, the executing is based on a temporary register associated with the at least two micro-operations. In embodiments, the temporary register is renamed. The renaming of the temporary register can enable OoO execution by decoupling the logical (program-visible) register names from the physical registers. This can allow independent instructions with false dependencies to execute simultaneously or in a different order, even if they appear to use the same logical registers. In embodiments, a first micro-operation within the at least two micro-operations comprises a load micro-operation, wherein a load address of the load micro-operations implicitly comprises the SSP, and wherein a destination address comprises the temporary register.

The second micro-operation (UOP1) includes an instruction to compare the temporary register with the X1 register. The second micro-operation (UOP1) has a ROBID of ROBID4. In embodiments, a second micro-operation within the at least two micro-operations comprises a compare micro-operation, wherein a first source operand of the compare micro-operation comprises the temporary register, and wherein a second source operand of the compare micro-operation comprises a stack pointer (SP). If the comparison matches, the execution continues to the third micro-operation (UOP2) where the value of the shadow stack pointer is added to a second immediate value of XLEN/8, which, in a decreasing stack paradigm, corresponds to an action to pop an entry from the shadow stack.

The third micro-operation (UOP2) has a ROBID of ROBID5. In embodiments, a third micro-operation within the at least two micro-operations comprises an increment micro-operation, wherein a source and a destination of the increment micro-operations implicitly comprise the SSP. If the comparison performed with micro-operation UOP1 indicates a mismatch, the following instruction which is executed results in generating a shadow stack fault 731. The shadow stack fault can have an exception handler associated with it, where the exception handler can execute a mitigation action. When a shadow stack fault exception is raised, it typically indicates a problem related to stack operations, such as exceeding stack bounds, improper stack alignment, or attempting to access invalid memory locations. The actions an exception handler might take depend on the context of the fault and the design of the system. The actions can include logging detailed information about the exception, such as the program counter, faulting instruction, stack pointer, and memory addresses involved. The actions can include termination of the program that caused the stack exception. Other mitigation actions may be used instead of, or in addition to, the aforementioned mitigation actions, in some implementations. The action can include informing the operating system of the fault.

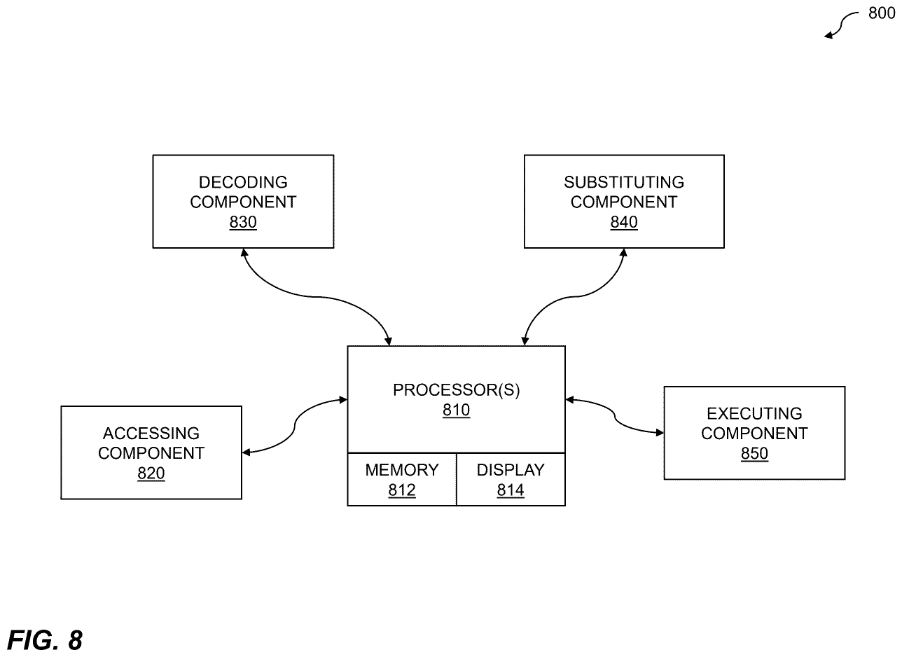

FIG. 8 is a system diagram for shadow stack management with micro-operations. The system 800 can include instructions and/or functions for design, generation of semiconductor logic for, and implementation of integrated circuits that support a shadow stack. The system 800 can include instructions and/or functions for design, generation of semiconductor logic for, and implementation of, integrated circuits that support a systolic array matrix-multiply accelerator with row tail accumulation. The system 800 can include instructions and/or functions for generation and/or manipulation of design data such as hardware description language (HDL) constructs for specifying structure and operation of an integrated circuit. The system 800 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

In disclosed implementations, semiconductor logic generation can be accomplished using hardware description languages (HDLs) such as Verilog or VHDL. These languages allow designers to specify digital circuits at the register transfer level (RTL), describing how signals flow between registers and how logical operations are performed. The HDL source code can be compiled and synthesized into gate level netlists that represent the actual semiconductor logic structures. At the RTL stage, disclosed implementations can capture both functional behavior and timing relationships. RTL descriptions are processed by synthesis tools that map the abstract operations into specific logic gates, flip flops, and interconnect structures. This process can enable automated generation of semiconductor logic that can be implemented in silicon, while preserving the intended arbitration and control functions originally specified. One or more implementations may include simulation of the HDL or RTL code prior to synthesis. Simulation environments allow verification of functional correctness, timing behavior, and corner cases. By running testbenches against the HDL code, designers can confirm that arbitration logic operates as intended before committing to gate level synthesis. Simulation also provides visibility into signal waveforms and processor request interactions, ensuring that the arbitration criteria are correctly enforced. One or more implementations may further involve common file formats used in the semiconductor design flow. HDL source files are typically stored in plain text formats (.v, .vhd), while synthesized netlists may be represented in formats such as EDIF or Liberty. Layout data is often exchanged in GDSII or OASIS formats. These standardized formats enable interoperability across tools and vendors, and support error checking during import/export.

Error checking can be an integral part of the flow. One or more implementations may include automated linting tools that detect undeclared signals, mismatched bit widths, or unused variables in HDL code. During synthesis and layout, design rule checks (DRC) and layout versus schematic (LVS) checks confirm that the generated semiconductor logic adheres to fabrication constraints and matches the intended design. One or more implementations may also address conflicts that arise in visualization and reporting. For example, waveform viewers and schematic generators may use color coding to distinguish signals, buses, and states. Conflicts in color assignments or overlapping graphical elements can obscure analysis. Tools therefore include configurable color palettes and conflict resolution mechanisms to ensure clarity in simulation results and design documentation. Finally, once synthesized and verified, the gate level netlist undergoes optimization and placement/routing to produce a physical layout suitable for fabrication. The resulting semiconductor logic embodies the arbitration mechanisms described in the HDL, ensuring that processor requests are managed according to dynamically assigned criteria. This tool-based flow demonstrates how software code can be transformed into concrete semiconductor logic structures, providing enabling support for claims directed to logic generation.

The system 800 can include one or more of processors, memories, cache memories, displays, and so on. The system 800 can include one or more processors 810. The processors can include standalone processors, processors within integrated circuits or chips, processor cores in FPGAs or ASICs, and so on. The one or more processors 810 are coupled to a memory 812, which stores instructions. The memory can include one or more of local memory, cache memory, system memory, etc. The system 800 can further include a display 814 coupled to the one or more processors 810. The display 814 can be used for displaying data, instructions, operations, micro-operations, shadow stack operations, and the like. The operations can include instructions and functions for implementation of integrated circuits, including processor cores. In exemplary implementations, the processor cores can include RISC-V™ processor cores. A system comprising the one or more processors 810, when executing the instructions which are stored in the memory 812, is configured to enable shadow stack management with micro-operations.

The system 800 can include an accessing component 820. The accessing component 820 can include functions and instructions for accessing a processor core, wherein the processor core is coupled to a memory hierarchy, and wherein the processor core is configured to execute vector operations, scalar operations, and micro-operations. The processor core can include an ARM core, a MIPS core, a RISC-V core, and/or other suitable core type. In one or more exemplary implementations, the processor core can include a RISC-V architecture. The processor core can support micro-operations. The RISC-V architecture can include extensions, where the extensions can enable execution of various arithmetic and logic operations. In exemplary implementations, a RISC-V architecture can include a Zicfiss extension. The Zicfiss extension can provide hardware support for protecting against control-flow attacks and stack corruption, which are common vulnerabilities exploited by malicious actors. Disclosed implementations can serve to protect against attacks, such as return-oriented programming (ROP) and jump-oriented programming (JOP), which exploit vulnerabilities to hijack the control flow of a program. The processor core can include a shadow stack, which can maintain a secure, hardware-managed copy of the program return addresses in a separate memory region. The shadow stack can include one or more stack pointers, return addresses, and so on. The processor core can include an execution pipeline, where the execution pipeline is configured to execute micro-operations. The micro-operations can include accessing a shadow stack pointer, a starting address for data, a source register, a destination register, and so on.

The system 800 can include a decoding component 830. The decoding component 830 can include functions and instructions for decoding a shadow stack operation, wherein the shadow stack operation is associated with a shadow stack pointer (SSP), and wherein the shadow stack operation is associated with an implementation mode. The shadow stack operation can include a push operation, pop operation, stack frame validation operation, and so on.

The system 800 can include a substituting component 840. The substituting component 840 can include functions and instructions for substituting the shadow stack operation with at least two micro-operations, wherein the substituting is based on the implementation mode. The micro-operations can include loading a value into the SSP. The micro-operations can include decrementing a value in the SSP. The micro-operations can include incrementing a value in the SSP. The micro-operations can include comparing a return address from the regular stack with a corresponding return address from the shadow stack. The micro-operations can include asserting a shadow stack fault in response to detecting a mismatch in a return address and/or other associated data between the regular stack and the shadow stack.

The system 800 can include an executing component 850. The executing component 850 can include functions and instructions for executing the at least two micro-operations. The micro-operations corresponding to an architectural instruction can be executed atomically. Interrupts can be disabled during execution of micro-instructions corresponding to an architectural instruction. Embodiments can include preventing interrupts from occurring between the at least two micro-operations.

The system 800 can include a computer program product embodied in a non-transitory computer readable medium for instruction execution, the computer program product comprising code which causes one or more processors to generate semiconductor logic for: accessing a processor core, wherein the processor core is coupled to a memory hierarchy, and wherein the processor core is configured to execute shadow stack operations and micro-operations; decoding a shadow stack operation, wherein the shadow stack operation is associated with a shadow stack pointer (SSP), and wherein the shadow stack operation is associated with an implementation mode; substituting the shadow stack operation with at least two micro-operations, wherein the substituting is based on the implementation mode; and executing the at least two micro-operations.

The system 800 can include a computer system for instruction execution comprising: a memory which stores instructions; one or more processors attached to the memory wherein the one or more processors, when executing the instructions which are stored, are configured to: access a processor core, wherein the processor core is coupled to a memory hierarchy, and wherein the processor core is configured to execute shadow stack operations and micro-operations; decode a shadow stack operation, wherein the shadow stack operation is associated with a shadow stack pointer (SSP), and wherein the shadow stack operation is associated with an implementation mode; substitute the shadow stack operation with at least two micro-operations, wherein the substituting is based on the implementation mode; and execute the at least two micro-operations.

As can now be appreciated, disclosed implementations provide support for a shadow stack using micro-operations. Stack-based attacks, such as stack smashing or buffer overflows, often manipulate return addresses on the main stack to redirect execution. The shadow stack feature of disclosed implementations can ensure that return addresses are stored in a secure and isolated area, making it extremely difficult for attackers to alter them. The shadow stack feature of disclosed embodiments can cross-check return addresses from the main stack with those stored in its secure memory. If any discrepancy is detected, the program can halt or trigger an exception, preventing unauthorized execution. In an era of increasing cyber threats, strong cybersecurity is vital for protecting sensitive data, ensuring system reliability, and maintaining user trust. The shadow stack of disclosed implementations directly addresses common vulnerabilities, making computer systems significantly harder to attack.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for instruction execution comprising:
accessing a processor core, wherein the processor core is coupled to a memory hierarchy, and wherein the processor core is configured to execute shadow stack operations and micro-operations;
decoding a shadow stack operation, wherein the shadow stack operation is associated with a shadow stack pointer (SSP), and wherein the shadow stack operation is associated with an implementation mode;
substituting the shadow stack operation with at least two micro-operations, wherein the substituting is based on the implementation mode; and
executing the at least two micro-operations.

2. The method of claim 1 wherein the shadow stack operation comprises an SSP push operation.

3. The method of claim 2 wherein a first micro-operation within the at least two micro-operations comprises a store micro-operation, wherein a store address of the store micro-operation implicitly comprises the SSP.

4. The method of claim 3 further comprising triggering an illegal instruction exception, by a load-store unit within the processor core, wherein an operand of the SSP push operation is not one or more specified integer registers.

5. The method of claim 4 wherein a second micro-operation within the at least two micro-operations comprises a decrement micro-operation.

6. The method of claim 5 wherein execution of the decrement micro-operation depends on a successful completion of the store micro-operation.

7. The method of claim 5 wherein a source and a destination of the decrement micro-operation implicitly comprise the SSP.

8. The method of claim 7 further comprising creating an immediate value, wherein the immediate value comprises a twos complement of an equation: [XLEN/8], wherein XLEN is a length of an integer register file, and wherein the immediate value is added to the SSP.

9. The method of claim 1 wherein the shadow stack operation comprises a SSP pop operation.

10. The method of claim 9 wherein the executing is based on a temporary register associated with the at least two micro-operations.

11. The method of claim 10 wherein the temporary register is renamed.

12. The method of claim 10 wherein a first micro-operation within the at least two micro-operations comprises a load micro-operation, wherein a load address of the load micro-operations implicitly comprises the SSP, and wherein a destination address comprises the temporary register.

13. The method of claim 12 wherein a second micro-operation within the at least two micro-operations comprises a compare micro-operation, wherein a first source operand of the compare micro-operation comprises the temporary register, and wherein a second source operand of the compare micro-operation comprises a stack pointer (SP).

14. The method of claim 13 further comprising setting a shadow stack fault, wherein the first source operand and the second source operand do not match.

15. The method of claim 13 wherein a third micro-operation within the at least two micro-operations comprises an increment micro-operation, wherein a source and a destination of the increment micro-operation implicitly comprises the SSP.

16. The method of claim 15 further comprising generating a second immediate value, wherein the second immediate value comprises a result of an equation: [XLEN/8], wherein XLEN is the length of an integer register file, and wherein the second immediate value is added to the SSP.

17. The method of claim 1 wherein the executing is accomplished out of order (OoO).

18. The method of claim 17 wherein the substituting includes assigning, by a reorder buffer (ROB), a ROBID associated with each of the at least two micro-operations.

19. The method of claim 18 further comprising dispatching the at least two micro-operations, wherein the dispatching is based on the ROBID.

20. The method of claim 19 further comprising completing the shadow stack operation, wherein the completing is based on a ROBID associated with each micro-operation within the at least two micro-operations.

21. The method of claim 1 further comprising preventing interrupts from occurring between the at least two micro-operations.

22. A computer program product embodied in a non-transitory computer readable medium for instruction execution, the computer program product comprising code which causes one or more processors to generate semiconductor logic for:
accessing a processor core, wherein the processor core is coupled to a memory hierarchy, and wherein the processor core is configured to execute shadow stack operations and micro-operations;
decoding a shadow stack operation, wherein the shadow stack operation is associated with a shadow stack pointer (SSP), and wherein the shadow stack operation is associated with an implementation mode;
substituting the shadow stack operation with at least two micro-operations, wherein the substituting is based on the implementation mode; and
executing the at least two micro-operations.

23. A computer system for instruction execution comprising:
a memory which stores instructions;
one or more processors coupled to the memory wherein the one or more processors, when executing the instructions which are stored, are configured to:
access a processor core, wherein the processor core is coupled to a memory hierarchy, and wherein the processor core is configured to execute shadow stack operations and micro-operations;
decode a shadow stack operation, wherein the shadow stack operation is associated with a shadow stack pointer (SSP), and wherein the shadow stack operation is associated with an implementation mode;
substitute the shadow stack operation with at least two micro-operations, wherein the substituting is based on the implementation mode; and
execute the at least two micro-operations.
